(19) United States
(12) Patent Application Publication
(10) Pub. No.: US 2024/0364181 A1
(43) Pub. Date: Oct. 31, 2024

(54) CONTACTING KIT AND METHOD FOR PRODUCING ELECTRIC MACHINES HAVING DIFFERENT POWER CLASSES

(71) Applicant: Vitesco Technologies Germany GmbH, Regensburg (DE)

(72) Inventors: Axel Gohs, Falkensee (DE); David Charles, Berlin (DE)

(73) Assignee: Vitesco Technologies Germany GmbH, Regensberg (DE)

(21) Appl. No.: 18/647,434

(22) Filed: Apr. 26, 2024

Related U.S. Application Data
(63) Continuation of application No. PCT/EP2022/080003, filed on Oct. 26, 2022.

(30) Foreign Application Priority Data
Nov. 9, 2021 (DE) 10 2021 212 577.8

(51) Int. Cl. H02K 5/22; H02K 3/28; H02K 3/50; H02K 15/00

(52) U.S. Cl. CPC H02K 5/225; H02K 3/28; H02K 3/50; H02K 15/0068

(57) ABSTRACT

A contacting kit for an electric machine which has a first contacting set having a multiplicity of contacting elements and a second contacting set having a multiplicity of contacting elements that are intended to establish contact between an energy supply device and a specific arrangement of protruding ends of coils that have been drawn into a stator, and a support body into which the contacting elements of the first and the second contacting set are insertable. Irrespective of which of the first or the second contacting set is inserted into the support body, the contacting elements are exposed at defined positions on an outer surface of the support body for contacting the protruding ends, such that, a first or a second winding pattern of the coils may be implemented by the selective insertion of the contacting elements of the first or the second contacting set into the support body.

### CROSS-REFERENCE TO RELATED APPLICATIONS

This application claims priority to PCT Application PCT/EP2022/080003, filed Oct. 26, 2022, which claims priority to German Patent Application No. DE 10 2021 210 577.8, filed Nov. 9, 2021. The disclosures of the above applications are incorporated herein by reference.

### FIELD OF THE INVENTION

The invention relates to a contacting kit for implementing contact between an energy supply device and coils of an electric machine, and to a method for producing electric machines in different power classes.

### BACKGROUND OF THE INVENTION

In the automotive industry, electric machines are increasingly installed during the production of motor vehicles. For example, automobile manufacturers operating on the market produce vehicles having hybrid drives, that is to say an internal combustion engine and an electric machine, or having fully electric drives. Electric machines are also used not only as drives but also in other applications, such as range extenders.

The vehicles produced have electric machines in different power classes depending on the size or weight of the motor vehicle and the price segment.

The corresponding method for producing these electric machines is such that coils are drawn identically into different stators that are assigned to different power classes, and the coils are subsequently contacted with one another in a so-called terminal box in order to implement a winding pattern of the relevant power class. Winding patterns for different power classes are for example star connections, for high peak torques at low rotational speeds, and delta connections, for high continuous torques at high rotational speeds. Serial and parallel connections in star or delta configurations, and double star and double delta connections, also exist as further refined gradations.

The bringing-together of the ends of the coils in the terminal box, and the corresponding contacting, is generally performed manually.

A certain remedial measure for simplifying the production method and creating variability in the power classes is described in the publication DE 10 2000 1702 09479 A1.

The document presents a terminal box which is designed to vary the winding pattern of the coils in electrically controlled fashion during driving operation of the motor vehicle in order that the corresponding electric machine switches to a different efficiency characteristic map or a different power class. For production, this means that only one form of contacting has to be implemented in the terminal box, and the method is thus simplified.

This terminal box is however electrically complex and expensive. Furthermore, the variability of the winding pattern during driving operation is simply not necessary in many applications, because vehicles in different classes and price segments operate highly satisfactorily with a fixed winding pattern.

### SUMMARY OF THE INVENTION

Against this background, it is an object of the invention to create a contacting kit and a method for producing electric machines in different power classes, which contacting kit and method allow the electric machines to be produced in automated fashion. It is at least an object of the invention to create an alternative contact and an alternative method for producing electric machines.

The object(s) is/are achieved by a contacting kit described and a method described. The description also relates to preferred embodiments.

According to one aspect of the invention, a contacting kit for implementing contact between an energy supply device and coils of an electric machine for a motor vehicle includes:
a first contacting set having a multiplicity of contacting elements that are intended to establish contact between the energy supply device and a specific arrangement of protruding ends of the coils, which have been drawn into a stator;
a second contacting set having a multiplicity of contacting elements that are intended to establish contact between the energy supply device and the specific arrangement of protruding ends; and
a support body into which the contacting elements of the first and the second contacting set are insertable; wherein
the contacting elements of the first and the second contacting set are designed such that, irrespective of which of the first or the second contacting set is inserted into the support body, the contacting elements are exposed at defined positions on an outer surface of the support body for the purposes of contacting the protruding ends, such that, for the specific arrangement of protruding ends of the coils, a first or a second winding pattern of the coils is implemented by the selective insertion of the contacting elements of the first or the second contacting set into the support body.

According to a further aspect of the invention, the contacting kit furthermore includes:
a third contacting set having a multiplicity of contacting elements that are intended to establish contact between the energy supply device and the specific arrangement of protruding ends of the coils, which have been drawn into the stator; and
a fourth contacting set having a multiplicity of contacting elements that are intended to establish contact between the energy supply device and the specific arrangement of protruding ends; wherein
the contacting elements of the third and the fourth contacting set are designed such that, irrespective of which of the third or the fourth contacting set is inserted into the support body, the contacting elements are exposed at the defined positions on the outer surface of the support body for the purposes of contacting the protruding ends, such that, for the specific arrangement of protruding ends of the coils, a third or a fourth winding pattern of the coils is implemented by the selective insertion of the contacting elements of the third or the fourth contacting set into the support body.

The specific arrangement of the protruding ends is such that a sequence of the ends and spatial positions of the ends, such as the spacings thereof, are defined.

The contacting kit according to the invention is intended for coils which are formed from bar windings, and the ends of which remain in the predetermined arrangement owing to inherent rigidity. If the coils are constructed from wire windings, the ends of which do not remain static owing to inherent rigidity, an adapter element is provided which holds the ends in the arrangement.

The contacting kit is provided for electric machines which are capable of motor and/or generator operation and which are used for example as a drive assembly of the motor vehicle. The energy supply device in an embodiment includes a high-voltage storage battery (for example 400 V or 800 V) and an inverter or converter that transforms the direct current provided by the storage battery into alternating current. The contacting elements and the support body are dimensioned for this field of use, that is to say have, for example, insulation characteristics and current carrying capacities required for this purpose.

The contacting elements are formed from metal and are monolithic bent/stamped parts which are bent into desired shapes so as to be exposed at the defined positions. In this regard, the contacting elements have, for example, bent tabs and/or bent portions.

According to a further preferred aspect of the contacting kit, this is designed such that
the contacting elements of the first contacting set include m contacting tongues for connection both to the energy supply device and to m phase windings of the first winding pattern formed from the coils, and include at least one bridge element that forms a star point of a star connection; wherein
the first winding pattern includes n>1 parallel coils in each of the m phase windings, and, for the corresponding implementation, the contacting elements of the first contacting set and the support body are configured such that, after the contacting elements have been inserted into the support body:
   each of the m contacting tongues is exposed at n of the defined positions on the outer surface of the support body for the purposes of contacting the protruding ends, and
   the star-point-forming bridge element is exposed at n*m of the defined positions on the outer surface of the support body for the purposes of contacting the protruding ends.

According to a further preferred aspect of the contacting kit, this is designed such that
the contacting elements of the second contacting set include m contacting tongues for connection both to the energy supply device and to m phase windings of the second winding pattern formed from the coils, and include a bridge element, which forms a star point of a star connection, and a multiplicity of serial bridge elements; wherein
the second winding pattern includes n>1 serially connected coils in each of the m phase windings, and, for the corresponding implementation, the contacting elements of the second contacting set and the support body are configured such that, after the contacting elements have been inserted into the support body:
   each of the m contacting tongues is exposed at one of the defined positions on the outer surface of the support body for the purposes of contacting the protruding ends,
   the star-point-forming bridge element is exposed at m defined positions on the outer surface of the support body for the purposes of contacting the protruding ends, and
   each of the serial bridge elements is exposed at two defined positions on the outer surface of the support body for the purposes of contacting the protruding ends.

According to a further preferred aspect of the contacting kit, this is designed such that
the contacting elements of the third contacting set include m contacting tongues for connection both to the energy supply device and to m phase windings of the third winding pattern formed from the coils, and include m connecting bridge elements; wherein
the third winding pattern is a delta connection and includes n>1 parallel-connected coils in each of the m phase windings, and,
for the corresponding implementation of the third winding pattern, the contacting elements of the third contacting set and the support body are configured such that, after the contacting elements have been inserted into the support body:
   each of the m contacting tongues is exposed at n of the defined positions on the outer surface of the support body for the purposes of contacting the protruding ends, and
   each of the m connecting bridge elements is contacted with one of the m contacting tongues and is exposed at n of the defined positions on the outer surface of the support body for the purposes of contacting the protruding ends.

According to a further preferred aspect of the contacting kit, this is designed such that
the contacting elements of the fourth contacting set include m contacting tongues for connection both to the energy supply device and to m phase windings, and include a multiplicity of serial bridge elements; wherein
the fourth winding pattern is a delta connection and includes n>1 serially connected coils in each of the m phase windings; and,
for the corresponding implementation of the fourth winding pattern, the contacting elements of the fourth contacting set and the support body are configured such that, after the contacting elements have been inserted into the support body:
   each of the m contacting tongues is exposed at two of the defined positions on the outer surface of the support body for the purposes of contacting the protruding ends, and
   each of the serial bridge elements is exposed at two of the defined positions on the outer surface of the support body for the purposes of contacting the protruding ends.

Aside from the four winding patterns discussed above (parallel-star, serial-star, parallel-delta and serial-delta), the contacting kit according to the invention may include yet further contacting sets that implement, for example, the following winding patterns:
double star, that is to say two independent star connections without parallel/serial connection of the coils;
double delta, that is to say two independent delta connections without parallel/serial connection of the coils;
double star, that is to say two independent star connections each with serial connections of coils, for multipole electric machines;
double delta, that is to say two independent delta connections each with parallel connections of coils, for multipole electric machines.

According to a further preferred aspect of the contacting kit, this is designed such that the support body includes m openings for the m contacting tongues, into which openings the contacting tongues are inserted in a predetermined direction, wherein the contacting tongues have bent tabs which, after the contacting tongues have been inserted, are exposed at the corresponding defined positions on the outer surface, and, after the contacting tongues have been inserted, the star-point-forming bridge element, the serial bridge elements and/or the connecting bridge elements are inserted with bent portions into the openings in the support body such that the bridge elements run in a plane that is offset with respect to the contacting tongues, cross the contacting tongues, and are exposed at corresponding positions from among the defined positions.

Insulating intermediate layers are arranged between the various planes.

The support body is designed such that the positions of the exposed contacting elements are situated in two parallel planes on the outer surface of the support body. There are, in an embodiment, a total of (n*m)*2 positions at which the contacting elements are exposed.

The bent tabs and/or the bent portions are, in an embodiment, bent through 90° or 180°.

The number of phase windings, that is to say the parameter m, is for example m=3, and the number of coils, that is to say the parameter n, is for example n=2.

A method according to the invention for producing electric machines in different power classes includes the following steps:
i. providing a multiplicity of stators which are assigned to in each case one of the different power classes, by virtue of the fact that the stators have different stator lengths along their respective longitudinal axes;
ii. drawing an equal number of coils into each of the stators such that ends of each of the coils are present at one end side of each stator;
iii. guiding the ends, which are present at the end side of each stator, such that the ends assume a predetermined arrangement, wherein the predetermined arrangement is implemented identically for the drawn-in windings of each of the stators;
iv. providing a contacting kit as discussed above;
v. establishing a different winding pattern for each of the different power classes by virtue of the corresponding contacting sets being inserted into the corresponding support body and being connected to the corresponding predetermined arrangement of the ends of the windings of the corresponding stator.

As already mentioned, the specific arrangement of the protruding ends is such that a sequence of the ends and spatial positions of the ends, such as the spacings thereof, are defined.

In step iii., the ends are brought into the specific arrangement by bending and torsion. The method is suitable for coils which are formed from bar windings, and the ends of which remain in the predetermined arrangement owing to inherent rigidity. If the coils are constructed from wire windings, the ends of which do not remain static owing to inherent rigidity, an adapter element is provided which holds the ends in the arrangement.

In step v., the connection is established by producing an integral bond, for example by laser welding. Alternative connecting methods are for example tungsten inert-gas welding, electron-beam welding, or brazing.

Steps i. to v., or steps iii. to v., are performed in automated fashion without manual intervention.

Major benefits that are achieved by the contacting kit according to the invention and the method according to the invention include the following:
Costs are lowered owing to large unit quantities of shared elements (shared components concept) an
one-off investment in manufacturing facilities through the use of shared facilities and process technologies, such as bending and stamping facilities for producing the contacting elements
The production method covers wide ranges of power classes owing to the uniform interface design of the stator
The contacting kit implements a uniform interface between stator and inverter for electric machines in different power classes, and has a uniform external shape for the different machines. The scope of testing and the design validation effort involved in the development process are thus reduced and standardized
The contacting elements are less complex elements
Low amounts of raw materials are used for the support body and the contacting elements.

A preferred embodiment of the contacting kit according to the invention, which is used in the production method according to the invention, is described below.

### BRIEF DESCRIPTION OF THE DRAWINGS

FIGS. 1A and 1B show perspective views of a contacting kit according to the invention, into which contacting elements have been inserted, wherein the contacting elements are exchangeable;

FIGS. 2A and 2B show perspective views of an electric machine having bar windings, to which the contacting kit according to FIGS. 1A and 1B has been fastened;

FIG. 2C schematically shows a specific arrangement or sequence of the open ends of the bar windings, which is implemented in the production method according to the invention irrespective of the power class and for which the contacting kit according to the invention is provided;

FIGS. 3A to 3D show a first contacting set having a multiplicity of contacting elements for the intended contacting between an energy supply device of the electric machine and the specific arrangement of the protruding ends of the bar windings from FIG. 2C, and a corresponding circuit diagram that shows a parallel-star configuration;

FIGS. 4A to 4C show a second contacting set having a multiplicity of contacting elements for the intended contacting between an energy supply device of the electric machine and the specific arrangement of the protruding ends of the bar windings from FIG. 2C, and a corresponding circuit diagram that shows a serial-star configuration;

FIGS. 5A to 5E show a third contacting set having a multiplicity of contacting elements for the intended contacting between an energy supply device of the electric machine and the specific arrangement of the protruding ends of the bar windings from FIG. 2C, and a corresponding circuit diagram that shows a parallel-delta configuration; and

FIGS. 6A to 6C show a fourth contacting set having a multiplicity of contacting elements for the intended contacting between an energy supply device of the electric machine and the specific arrangement of the protruding ends of the bar windings from FIG. 2C, and a corresponding circuit diagram that shows a serial-delta configuration.

### DETAILED DESCRIPTION OF THE PREFERRED EMBODIMENTS

The following description of the preferred embodiment(s) is merely exemplary in nature and is in no way intended to limit the invention, its application, or uses.

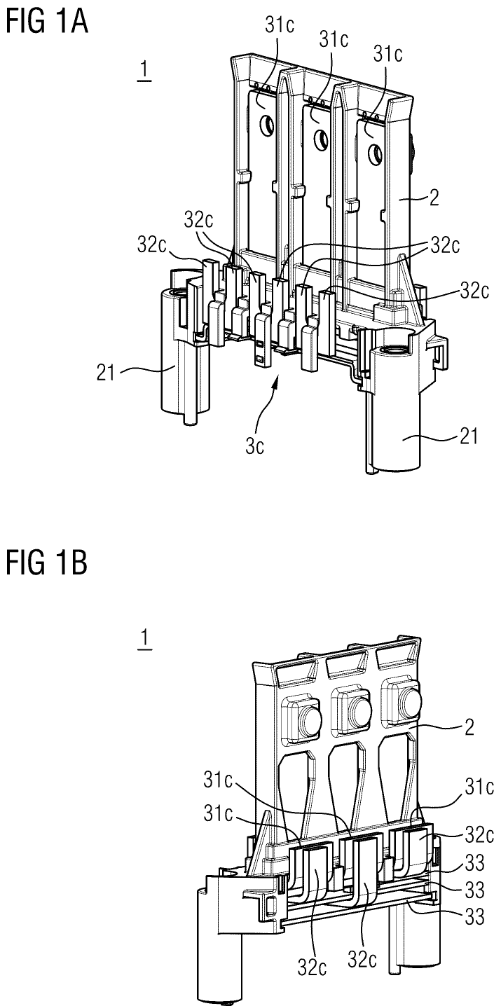

FIGS. 1A and 1B show a contacting kit 1 according to the invention in one embodiment of the invention.

The contacting kit 1 includes a support body 2 and a contacting set having a multiplicity of contacting elements 3c that are inserted into the support body 2 and are intended to establish contact between an energy supply device (not shown) and a specific arrangement/spatial sequence, to be discussed in more detail further below, of protruding ends of coils that have been drawn into a stator.

The support body 2 is an injection-molded part composed of plastics material, which receives and holds the contacting elements 3c. The support body 2 furthermore includes fastening portions 21 by which the contacting kit 1 may be fastened in a housing (not shown) of an electric machine. The fastening is performed for example by screw connections, with the corresponding screws for this purpose being inserted into passages formed in the fastening portions 21 and being connected to threads formed on the housing.

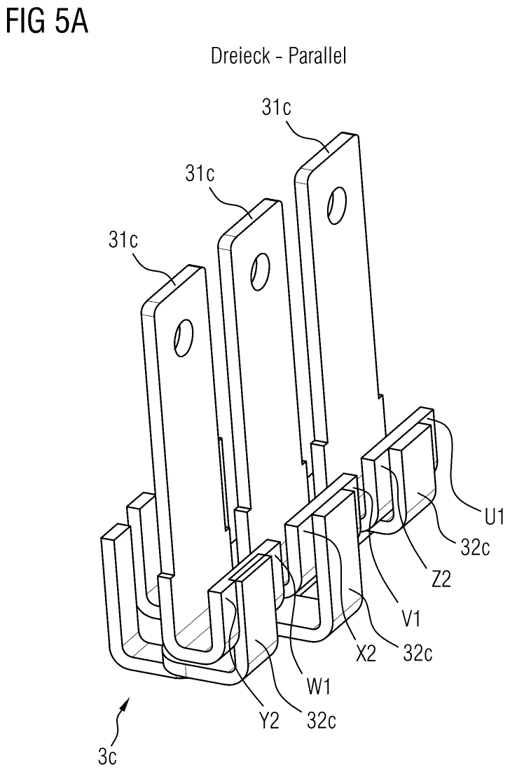

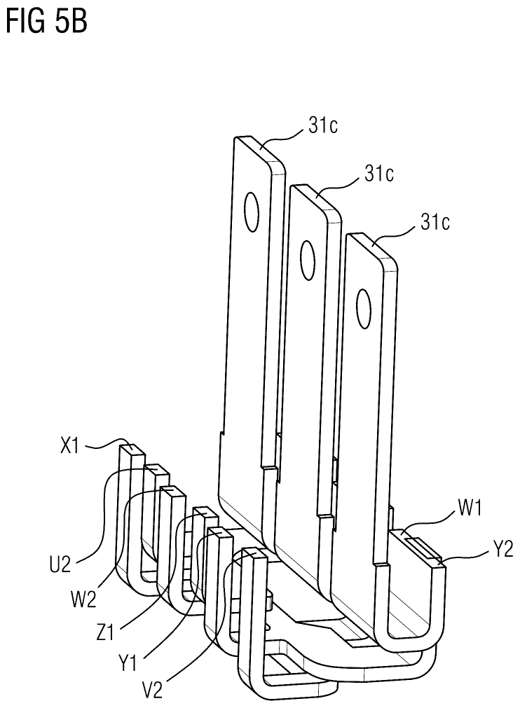

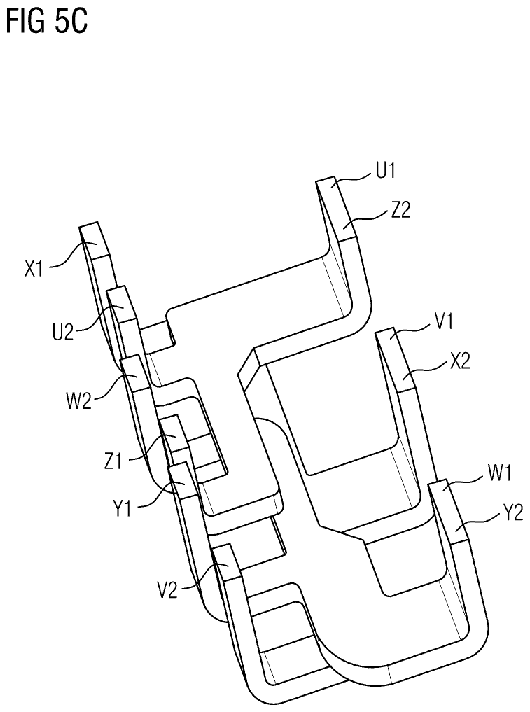

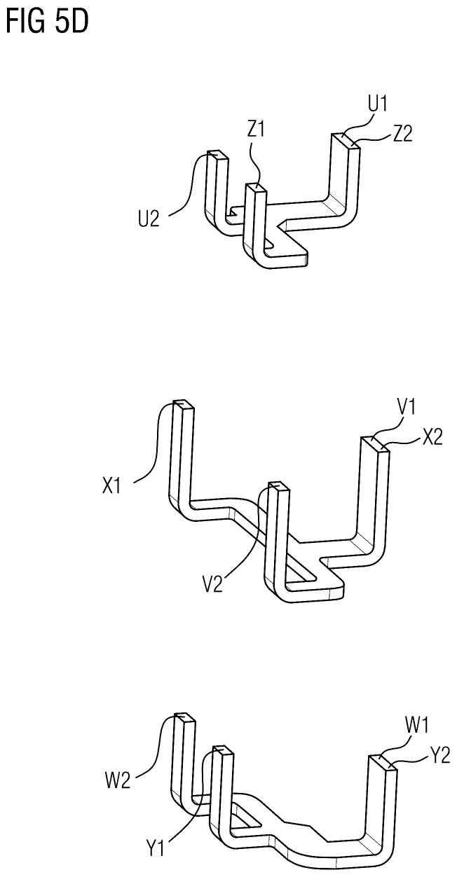

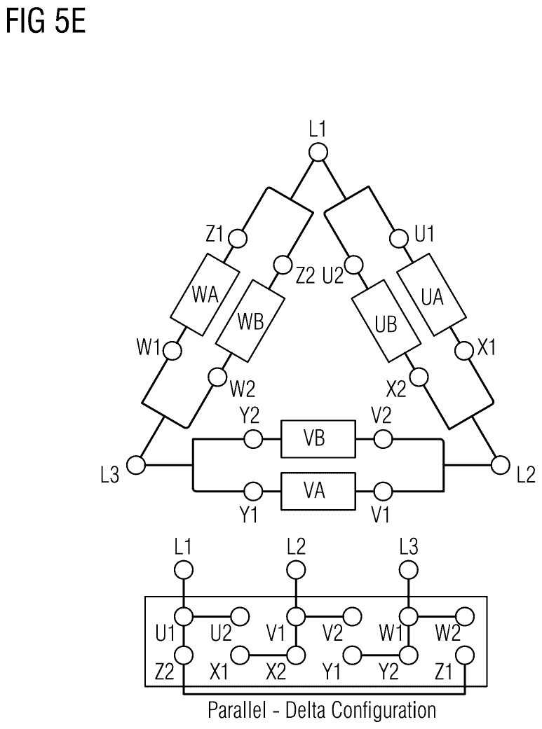

According to the invention, the contacting kit 1 shown includes not only the contacting set shown but also at least one further contacting set, which also includes a multiplicity of contacting elements. In an embodiment, but without limitation hereto, the contacting kit 1 includes four contacting sets, to be discussed in more detail further below, which each have a multiplicity of contacting elements 3a, 3b, 3c, and 3d, wherein the contacting set shown in FIGS. 1A and 1B corresponds to that shown in FIGS. 5A to 5E.

The support body 2 and the contacting sets are designed such that each of the contacting sets may be selectively inserted into the support body 2 without the need for any modification of the support body 2.

The contacting elements 3c shown in FIGS. 1A and 1B include contacting tongues 31c, which are each connected to the energy supply device (not shown), and connecting bridge elements 32c.

The energy supply device includes, for example, a high-voltage storage battery (for example 400 V or 800 V) and a converter or inverter that generates alternating current from the direct current provided by the energy store. To operate the electric machine, to be discussed in more detail further below, the converter outputs a total of three phases (L1, L2, L3), wherein each of the three phases is intended to be contacted with one of the three contacting tongues 31c.

The contacting or connection between the contacting tongues 31c and the relevant phase is implemented for example by a screw connection between corresponding busbars and the corresponding contacting tongue 31c or, for example, by a corresponding three-phase plug that is intended to be brought together with the support body 2 shown in FIGS. 1A and 1B.

The contacting tongues 31c furthermore have bent tabs which, as shown in FIG. 1B, are exposed in a specific sequence on an outer surface of the support body 2 and are bent through 180°.

The connecting bridge elements 32c are also intended to be inserted into the support body 2. The connecting bridge elements 32c are, as shown in FIG. 1B, connected to or contacted with the bent tabs of the contacting tongues 31c, and also run through the support body 2 so as to be exposed at correspondingly defined positions in a particular sequence on the averted side, which is shown in FIG. 1A. For this purpose, those portions of the connecting bridge elements 32c which are shown in FIG. 1A are bent through 90°.

A comparison of FIGS. 1A and 1B shows that the tabs of the contacting tongues 31c and the bent portions of the connecting bridge elements 32c are exposed at the defined positions on both sides of the support body 2, the positions being situated in two mutually parallel planes.

The aforementioned bar winding of the electric machine is intended to be connected, at the defined positions, to the contacting tongues 31c and the connecting bridge elements 32c, as discussed in more detail further below.

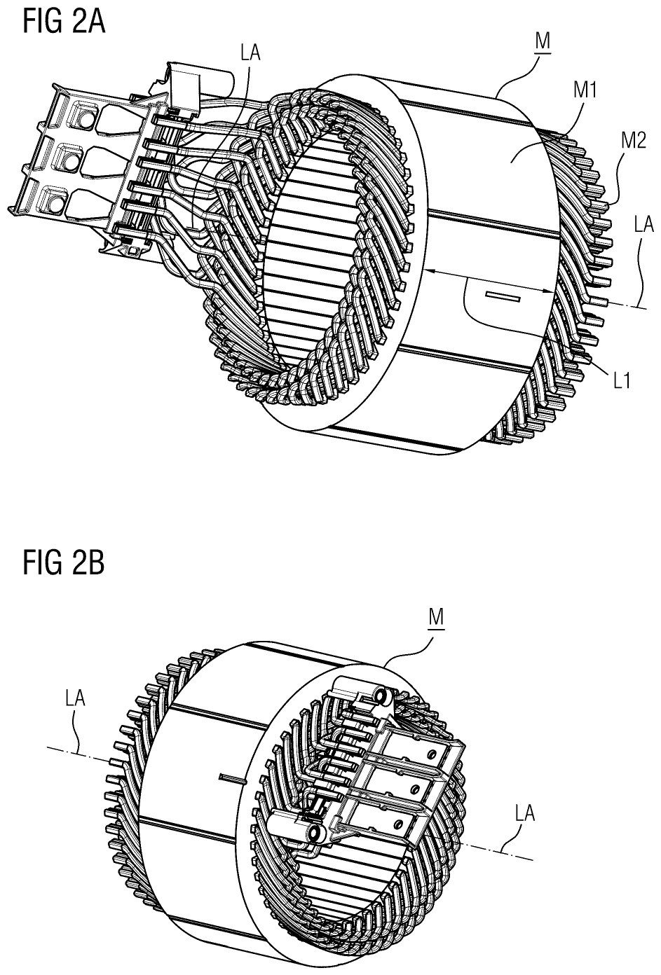

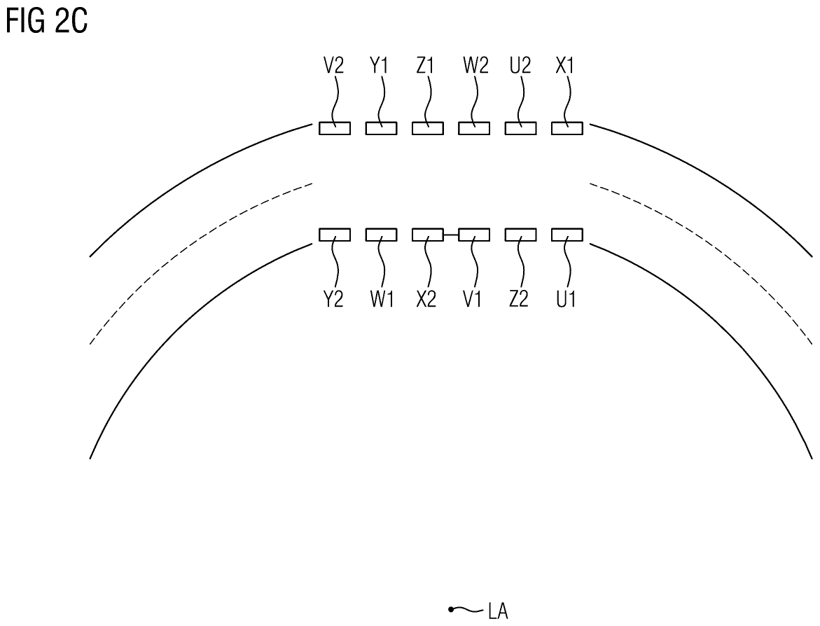

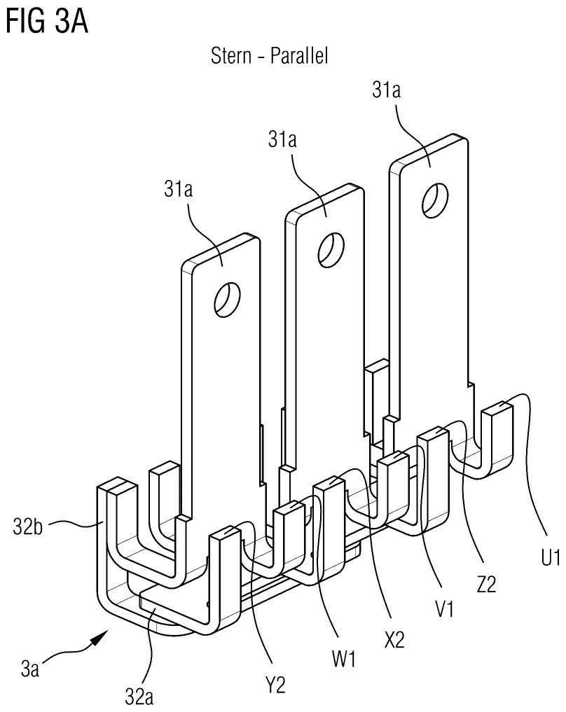

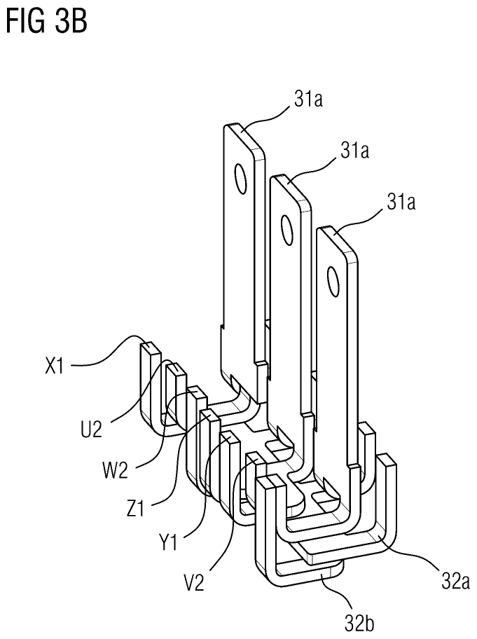

FIGS. 2A and 2B show perspective views of an electric machine M in a specific power class, which electric machine includes a stator M1 and a multiplicity of coils M2 that have been drawn into the stator Ml.

The stator M1 is ring-shaped, and in an embodiment is circular-ring-shaped, and defines an interior space into which a rotor (not shown) of the electric machine is inserted. The stator M1 and the correspondingly defined interior space are rotationally symmetrical about a corresponding longitudinal axis, which is shown in FIGS. 2A and 2B and which corresponds to an axis of rotation of the rotor (not shown). A multiplicity of grooves, into which the coils M2 are drawn, are formed on a side of the stator M1 that faces toward the interior space and the longitudinal axis LA. The stator M1 has dimensions or a length L1 in the direction of the longitudinal axis LA.

The drawn-in coils M2 are implemented as bar windings. In the embodiment, a total of six coils M2 have been drawn into the stator M1, wherein the corresponding ends of the coils M2 protrude from one of the sides of the stator M1.

As may be seen from FIGS. 2A and 2B, the protruding ends of the coils M2 are contacted with, and thus electrically connected to, the tabs of the contacting tongues 31c and the bent portions of the connecting bridge elements 32c at the defined positions on the outer surface of the support body 2.

According to the invention, the contacting kit 1 allows standardized production and implementation of electric machines in different power classes. The electric machines in different power classes differ by the fact that, firstly, the corresponding stators M1 have different dimensions L1 in the direction of their respective longitudinal axes and different winding patterns of the corresponding coils. According to the invention, in order to standardize the corresponding production method, the following steps are carried out:

In a first step, a multiplicity of stators is provided, the stators differing in terms of their dimensions or lengths L1.

Subsequently, an equal number of coils is drawn into the corresponding grooves of each stator that is provided. The coils are situated in identical grooves in each stator. That is to say, the system of arranging the coils in the respective grooves is identical, such as with regard to the respective coil widths and layering, for all stators.

It is of key significance that, after the coils have been drawn into the stators M1 in different power classes, the respective ends of the coils M2 are situated at one end side of each stator Ml.

These ends of the drawn-in coils M2 are thereupon bent, and twisted, so as to assume a predetermined arrangement. The arrangement is implemented identically for all stators or the correspondingly drawn-in coils M2. In other words, the arrangement of the protruding ends of the coils is identical, irrespective of the power class of the electric machine that is ultimately produced. The predetermined arrangement of the protruding ends is identical with regard to the sequence of the ends of the coils M2 and with regard to the spatial positions thereof.

FIG. 2C schematically shows a preferred predetermined arrangement of the protruding ends of the drawn-in coils M2. In the method, it is the case that six coils (UA, UB, VA, VB, WA, WB) are drawn into each of the stators Ml, and the corresponding ends are bent such that the resulting open ends assume the arrangement in FIG. 2C. The open ends are labeled in FIG. 2C with the abbreviations X1, X2, Y1, Y2, Z1, Z2, U1, U2, V1, V2, and W1, W2. FIG. 2C corresponds to a schematic view of the open ends of the coils as viewed in the direction of the longitudinal axis LA, that is to say the longitudinal axis LA is perpendicular to the plane of the drawing in FIG. 2C.

In this embodiment, the open ends of the coils have been bent into the predetermined arrangement so as to be situated in two mutually parallel planes. A sequence of the open ends of the coils M2 in the outer plane as viewed radially with respect to the longitudinal axis LA is V2, Y1, Z1, W2, U2, X1, and that in the inner plane as viewed radially with respect to the longitudinal axis LA is Y2, W1, X2, V1, Z2, U1.

In a further step of the production method according to the invention, the power classes of the corresponding electric machines are furthermore differentiated, aside from their longitudinal dimensions L1, in that the correspondingly drawn-in coils are interconnected to form different winding patterns in each case. The contacting kit 1 according to the invention is used for this step.

As already discussed, the contacting kit 1 includes the support body 2 and a multiplicity of different contacting sets with different contacting elements 3a, 3b, 3c, and 3d. The support body 2 and the respective contacting elements 3a, 3b, 3c and 3d are configured such that the contacting elements 3a, 3b, 3c and 3d may be selectively inserted into the support body 2, but the positions at which the respective contacting elements are exposed on the outer surface of the support body 2 do not change. In other words, the positions at which the contacting elements 3a, 3b, 3c, 3d are exposed are independent of which of the contacting elements 3a, 3b, 3c, and 3d are inserted into the support body.

The support body 2 and the contacting elements 3a, 3b, 3c and 3d are dimensioned such that the defined positions at which the contacting elements 3a, 3b, 3c, 3d are exposed match the spatial arrangement of the protruding ends as shown in FIG. 2C.

The contacting elements 3a, 3b, 3c, 3d of each of the contacting sets are furthermore designed such that each contacting set implements a different winding pattern. Therefore, in the method according to the invention, a decision is made as to the manner in which the coils M2 of the electric machine presently being produced are to be interconnected, and one of the contacting sets, or the corresponding contacting elements 3a, 3b, 3c, 3d, is or are selected.

After the corresponding contacting set has been selected and the corresponding contacting elements have been inserted into the support body 2, the support body is inserted between the planes shown in FIG. 2C, whereby the protruding ends of the coils come into contact with the contacting elements at the defined positions. The protruding ends are subsequently integrally bonded to the contacting elements, for example are welded thereto by laser welding.

Yet further steps that are not essential to the invention, such as the installation of a housing etc., may be performed subsequently in the production method.

In the present embodiment, in the production method according to the invention, in each case six coils are drawn into the stators in different power classes.

Four exemplary winding patterns that are implemented by the contacting kit 1 according to the invention are discussed below.

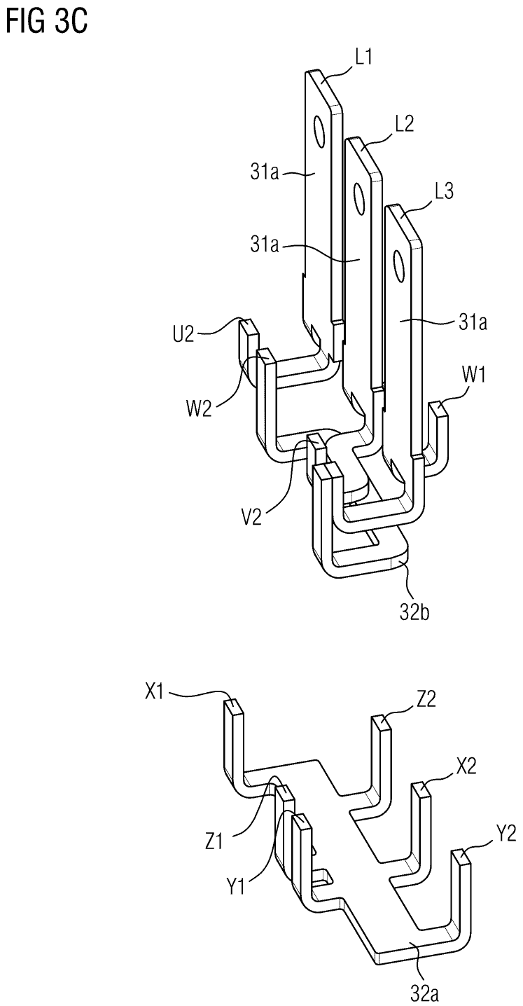

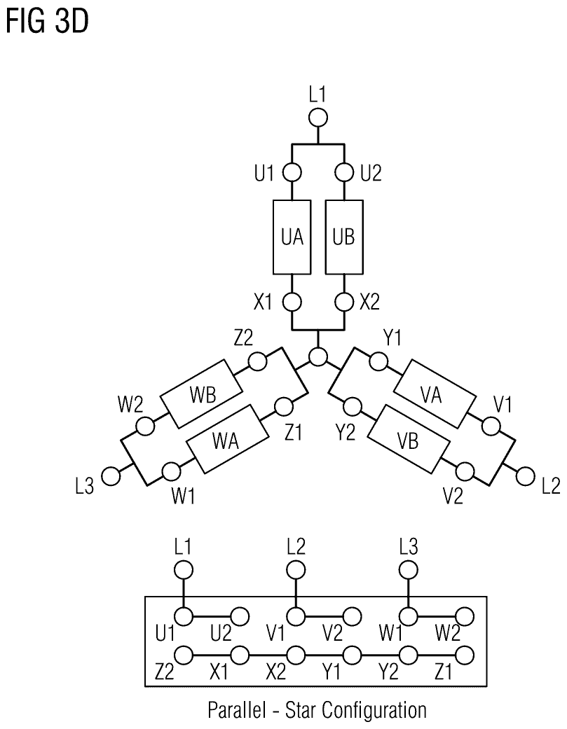

FIGS. 3A to 3C show contacting elements 3a, which is inserted into the support body 2, of a first contacting set. The contacting elements 3a include three contacting tongues 31a, a star-point-forming bridge element 32a, and a further connecting bridge element 32b. FIGS. 3A and 3B show the contacting elements 3a in their relative arrangement in which they are present after being inserted into the support body 2. By contrast, FIG. 3C shows the contacting elements 3a in an exploded view.

The first contacting set includes three contacting tongues 31a for the three current phases L1, L2, L3 that are output by the converter. Each of the contacting tongues 31a includes two bent tabs which, after the corresponding contacting tongue 31a has been inserted into the support body 2, are exposed at respective positions from among the defined positions.

The star-point-forming bridge element 32a includes a total of six bent portions which, after the star-point-forming bridge element 32a has been inserted into the support body 2, are exposed at respective positions from among the defined positions.

FIGS. 3A to 3C show which of the defined positions the respective bent tabs of the contacting tongues 31a and the bent portions of the star-point-forming bridge element 32a are exposed at, and which of the protruding ends of the coils M2 the bent tabs and bent portions correspond to.

It is apparent from this that the contacting elements 3a, after being inserted into the support body 2 and being contacted with the arrangement of the protruding ends of the coils M2 as per FIG. 2C, implement the first winding pattern shown in FIG. 3D. It is seen that the first winding pattern constitutes a star connection, wherein the star-point-forming bridge element 32a defines a corresponding star point, each of the three contacting tongues 31a is assigned to one of the three phase windings, and, in each phase winding, two of the six coils are connected in parallel.

The further connecting bridge element 32b is merely provided, and serves to reduce the complexity of the bent tabs of the contacting tongue 31a that corresponds to the current phase L3. This is achieved in that the connecting bridge element 32b is, at one end, exposed at the position of the protruding end W2 and, at the other end, contacted with the bent tab of the contacting tongue 31a. The contact is established by a form fit. In other words, the connecting bridge element 32b merely redirects the bent tab, as may be seen clearly in FIG. 3C, and does not connect any two ends of the coils. Alternatively, the bent tab of the contacting tongue 31a may be bent such that the connecting bridge element 32b may be omitted.

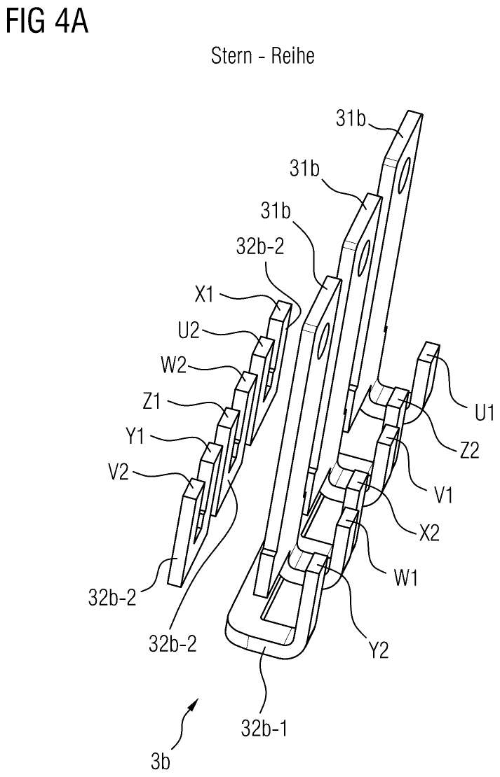

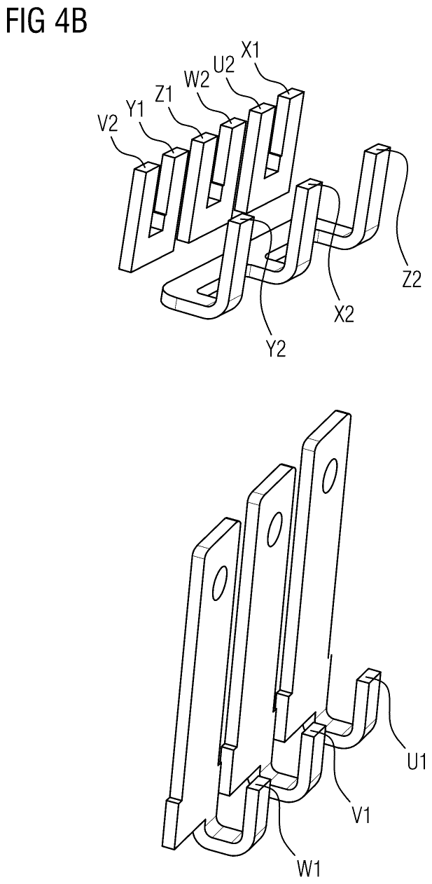

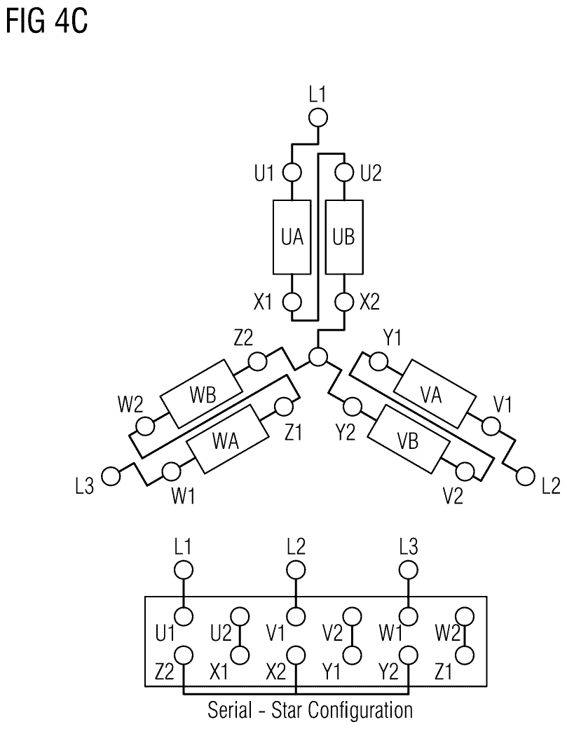

FIGS. 4A and 4B show contacting elements 3b, which are inserted into the support body 2, of a second contacting set. The contacting elements 3b include three contacting tongues 31b and a multiplicity of bridge elements 32b.

FIG. 4A shows the contacting elements 3b in their relative arrangement in which they are present after being inserted into the support body 2. By contrast, FIG. 4B shows the contacting elements 3b in an exploded view.

The second contacting set includes three contacting tongues 31b for the three current phases L1, L2, L3 that are output by the converter. Each of the contacting tongues 31b includes a bent tab which, after the corresponding contacting tongue 31b has been inserted into the support body 2, is exposed at one of the defined positions.

A star-point-forming bridge element 32b-1 of the bridge elements 32b includes a total of three bent portions which, after the bridge element 32b-1 has been inserted into the support body 2, are exposed at respective positions from among the defined positions. Further serial bridge elements 32b-2 are each U-shaped and are each exposed at two of the defined positions.

FIGS. 4A and 4B show which of the defined positions the respective bent tabs of the contacting tongues 31 b and the portions of the bridge elements 32b are exposed at, and which of the protruding ends of the coils M2 the bent tabs and portions correspond to.

It is apparent from this that the contacting elements 3b, after being inserted into the support body and being contacted with the arrangement of the protruding ends of the coils M2 as per FIG. 2C, implement the second winding pattern shown in FIG. 4C. It is seen that the second winding pattern again constitutes a star connection, wherein the star-point-forming bridge element 32b-1 defines a corresponding star point, each of the three contacting tongues 31b is assigned to one of the three phase windings, and, in each phase winding, two of the six coils are connected in series. The connection of the corresponding coils in series is implemented by the further serial bridge elements 32b-2.

FIGS. 5A to 5E show contacting elements 3c, which are inserted into the support body 2, of a third contacting set. The contacting elements 3c include three contacting tongues 31c and a multiplicity of connecting bridge elements 32c.

FIGS. 5A and 5B show the contacting elements 3c in their relative arrangement in which they are present after being inserted into the support body 2. FIG. 5C shows the relative arrangement of the connecting bridge elements 32c after they have been inserted into the support body 2, and FIG. 5D shows the respective connecting bridge elements 32c in an exploded view.

The third contacting set includes three contacting tongues 31c for the three current phases L1, L2, L3 that are output by the converter. Each of the contacting tongues 31c includes a bent tab which, after the corresponding contacting tongue 31c has been inserted into the support body 2, is exposed at two of the defined positions. Here, one tab forms two of the defined positions simultaneously.

Each of the connecting bridge elements 32c includes a total of three bent portions, two of which are exposed at two of the defined positions after the connecting bridge element 32c has been inserted into the support body 2. The remaining third bent portion is connected to in each case one of the contacting tongues 31c, specifically in such a way that the third bent portion divides the bent tab of the contacting tongues 31c into the corresponding two of the defined positions.

FIGS. 5A to 5D show which of the defined positions the respective bent tabs of the contacting tongues 31c and the bent portions of the connecting bridge elements 32c are exposed at, and which of the protruding ends of the coils M1 the bent tabs and bent portions correspond to.

It is apparent from this that the contacting elements 3c, after being inserted into the support body 2 and being contacted with the arrangement of the protruding ends of the coils M2 as per FIG. 2C, implement the third winding pattern shown in FIG. 5E. It is seen that the third winding pattern constitutes a delta connection, wherein the bent tabs of the contacting tongues 31c make twofold contact with in each case one of the three phase windings; in each phase winding, two of the six coils are connected in parallel; and the connecting bridge elements 32c implement the twofold connection to another of the phase windings.

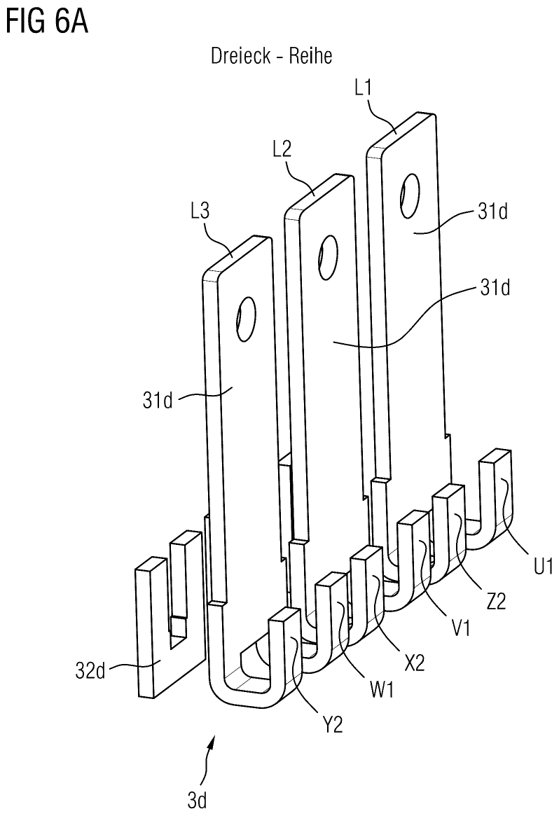

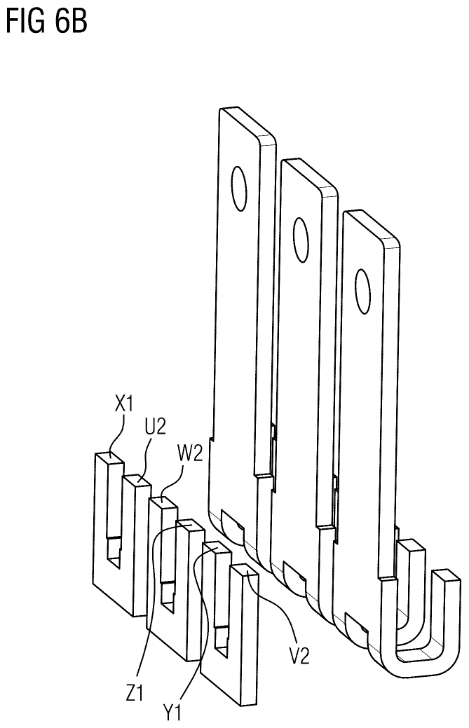

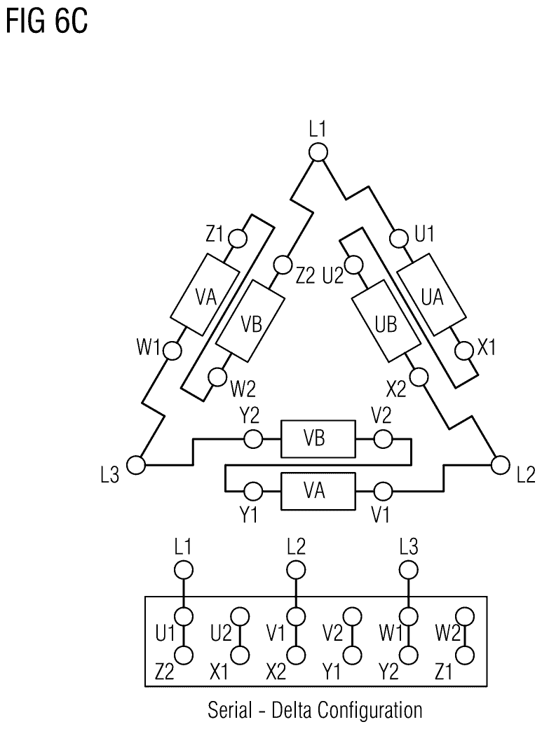

FIGS. 6A and 6B show contacting elements 3d, which is inserted into the support body 2, of a fourth contacting set. The contacting elements 3d include three contacting tongues 31d and a multiplicity of U-shaped serial bridge elements 32d.

FIGS. 6A and 6B show the contacting elements 3d in their relative arrangement in which they are present after being inserted into the support body 2.

The fourth contacting set includes three contacting tongues 31d for the three current phases L1, L2, L3 that are output by the converter. Each of the contacting tongues 31d includes two bent tabs which, after the corresponding contacting tongue 31d has been inserted into the support body 2, are exposed at two of the defined positions.

Each of the serial bridge elements 32d is U-shaped and is exposed at two of the defined positions. The serial bridge elements are identical to the serial bridge elements 32b-2 from FIG. 4A.

FIGS. 6A and 6B show which of the defined positions the respective bent tabs of the contacting tongues 31d and the portions of the serial bridge elements 32d are exposed at, and which of the protruding ends of the coils M2 the bent tabs and portions correspond to.

It is apparent from this that the contacting elements 3d, after being inserted into the support body 2 and being contacted with the arrangement of the protruding ends of the coils M2 as per FIG. 2C, implement the fourth winding pattern shown in FIG. 6C. It is seen that the fourth winding pattern constitutes a delta connection, wherein the bent tabs of the contacting tongues 31d contact in each case two of the three phase windings; in each phase winding, two of the six coils are connected in series; and the serial bridge elements 32d implement the connection of the coils in series in each phase winding.

From the above illustrations of the individual contacting elements 3a, 3b, 3c, 3d of the four contacting sets, it is apparent that the connections of the protruding ends of the coils M2 as implemented by the contacting elements cross one another in certain portions. For this reason, the support body 2 and the contacting elements are designed such that the contacting elements may cross one another in different planes.

FIGS. 1A and 1B show the contacting kit 1 in its assembled state, with the third contacting set and the corresponding contacting elements 3c having been inserted. It is seen from FIG. 1B in combination with FIGS. 5A to 5D that the individual contacting elements run in different planes in order to realize criss-crossing connections, wherein planar insulating elements are inserted between the contacting elements of different planes.

As is apparent from the above description, the contacting elements of all contacting sets of the contacting kit according to the invention are elements that may be produced on the basis of identical manufacturing technology. All elements are single-piece, monolithic bent and/or stamped parts that are formed from metal plates.

The statements preceding the description of the Figures apply equally to the embodiments of the production method according to the invention and to the contacting kit according to the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A contacting kit for implementing contact between an energy supply device and coils of an electric machine for a motor vehicle, the contacting kit comprising:
a first contacting set having a multiplicity of contacting elements which establish contact between the energy supply device and an arrangement of protruding ends of the coils, which have been drawn into a stator;
a second contacting set having a multiplicity of contacting elements which establish contact between the energy supply device and the specific arrangement of protruding ends of the coils; and
a support body into which the multiplicity of contacting elements of the first contacting set and the multiplicity of contacting elements of the second contacting set are insertable;
wherein the multiplicity of contacting elements of the first contacting set and the multiplicity of contacting elements of the second contacting set are designed such that, irrespective of which of the multiplicity of contacting elements of the first contacting set or the multiplicity of contacting elements of the second contacting set is inserted into the support body, the multiplicity of contacting elements are exposed at defined positions on an outer surface of the support body for the purposes of contacting the protruding ends of the coils, such that, for the specific arrangement of protruding ends of the coils, a first or a second winding pattern of the coils is implemented by the selective insertion of the multiplicity of contacting elements of the first contacting set or the multiplicity of contacting elements of the second contacting set into the support body.

2. The contacting kit of claim 1, the multiplicity of contacting elements of the first contacting set further comprising:
m contacting tongues for connection both to the energy supply device and to m phase windings of the first winding pattern formed from the coils, and
at least one bridge element that forms a star point of a star connection;
wherein the first winding pattern comprises n>1 parallel coils in each of the m phase windings, and, for the corresponding implementation, the multiplicity of contacting elements of the first contacting set and the support body are configured such that, after the multiplicity of contacting elements of the first contacting set have been inserted into the support body:
each of the m contacting tongues is exposed at n of the defined positions on the outer surface of the support body for the purposes of contacting the protruding ends of the coils, and
the star-point-forming bridge element is exposed at n*m of the defined positions on the outer surface of the support body for the purposes of contacting the protruding ends of the coils.

3. The contacting kit of claim 1, the multiplicity of contacting elements of the second contacting set further comprising:
m contacting tongues for connection both to the energy supply device and to m phase windings of the second winding pattern formed from the coils;
a bridge element, which forms a star point of a star connection, and a multiplicity of serial bridge elements;
wherein the second winding pattern comprises n>1 serially connected coils in each of the m phase windings, and, for the corresponding implementation, the multiplicity of contacting elements of the second contacting set and the support body are configured such that, after the contacting elements have been inserted into the support body:
each of the m contacting tongues is exposed at one of the defined positions on the outer surface of the support body for the purposes of contacting the protruding ends of the coils;
the star-point-forming bridge element is exposed at m defined positions on the outer surface of the support body for the purposes of contacting the protruding ends of the coils; and
each of the serial bridge elements is exposed at two defined positions on the outer surface of the support body for the purposes of contacting the protruding ends of the coils.

4. The contacting kit of claim 1, further comprising:
a third contacting set having a multiplicity of contacting elements which establish contact between the energy supply device and the specific arrangement of protruding ends of the coils, which have been drawn into the stator; and
a fourth contacting set having a multiplicity of contacting elements which establish contact between the energy supply device and the specific arrangement of protruding ends of the coils;
wherein the multiplicity of contacting elements of the third contacting set and the multiplicity of contacting elements of the fourth contacting set are designed such that, irrespective of which of the multiplicity of contacting elements of the third contacting set or the multiplicity of contacting elements of the fourth contacting set is inserted into the support body, the contacting elements are exposed at the defined positions on the outer surface of the support body for the purposes of contacting the protruding ends of the coils, such that, for the specific arrangement of the protruding ends of the coils, a third or a fourth winding pattern of the coils is implemented by the selective insertion of the multiplicity of contacting elements of the third contacting set or the multiplicity of contacting elements of the fourth contacting set.

5. The contacting kit of claim 4, the multiplicity of contacting elements of the third contacting set further comprising:
m contacting tongues for connection both to the energy supply device and to m phase windings of the third winding pattern formed from the coils;
m connecting bridge elements;
wherein the third winding pattern is a delta connection and comprises n>1 parallel-connected coils in each of the m phase windings, and, for the corresponding implementation of the third winding pattern, the multiplicity of contacting elements of the third contacting set and the support body are configured such that, after the multiplicity of contacting elements of the third contacting set have been inserted into the support body:
each of the m contacting tongues is exposed at n of the defined positions on the outer surface of the support body for the purposes of contacting the protruding ends of the coils; and
each of the m connecting bridge elements is contacted with one of the m contacting tongues and is exposed at n of the defined positions on the outer surface of the support body for the purposes of contacting the protruding ends of the coils.

6. The contacting kit of claim 5, the multiplicity of contacting elements of the fourth contacting set further comprising:
m contacting tongues for connection both to the energy supply device and to m phase windings;
a multiplicity of serial bridge elements;
wherein the fourth winding pattern is a delta connection and comprises n>1 serially connected coils in each of the m phase windings, and, for the corresponding implementation of the fourth winding pattern, the multiplicity of contacting elements of the fourth contacting set and the support body are configured such that, after the multiplicity of contacting elements of the fourth contacting set have been inserted into the support body:
each of the m contacting tongues is exposed at two of the defined positions on the outer surface of the support body for the purposes of contacting the protruding ends of the coils; and
each of the serial bridge elements is exposed at two of the defined positions on the outer surface of the support body for the purposes of contacting the protruding ends of the coils.

7. The contacting kit of claim 1, the support body further comprising:
m openings for the m contacting tongues, into which openings the contacting tongues are inserted in a predetermined direction;
wherein the contacting tongues have bent portions which, after the contacting tongues have been inserted, are exposed at the corresponding defined positions on the outer surface, and, after the contacting tongues have been inserted, the bridge elements are inserted into the openings in the support body such that the bridge elements run in a plane that is offset with respect to the contacting tongues, cross the contacting tongues, and are exposed at corresponding positions from among the defined positions.

8. A method for producing electric machines in different power classes, comprising the steps of:
i. providing a multiplicity of stators which are assigned to in each case one of the different power classes, each of the multiplicity of stators having different stator lengths along their respective longitudinal axes;
ii. drawing an equal number of coils into each of the multiplicity of stators such that ends of each of the coils are present at one end side of each of the multiplicity of stators;
iii. guiding the ends of each of the coils, which are present at the end side of each of the multiplicity of stators, such that the ends of each of the coils assume a predetermined arrangement, and the predetermined arrangement is implemented identically for the drawn-in windings of each of the multiplicity of stators;
iv. providing a contacting kit of claim 1;
v. establishing a different winding pattern for each of the different power classes by virtue of the corresponding contacting sets being inserted into the support body and being connected to the corresponding predetermined arrangement of the ends of the windings of the corresponding one of the multiplicity of stators.

9. The method of claim 8, wherein step ii. further comprises drawing bar windings into the stators.

10. The method of claim 9, wherein step iii. further comprises implementing the predetermined arrangement by virtue of the ends of the bar windings being bent and remaining stationary in the predetermined arrangement owing to inherent stability of the bar windings.

11. The method of claim 8, wherein step iii further comprises bending and twisting the ends such that the ends are arranged, in accordance with the predetermined arrangement, in two mutually parallel planes.
